(19) United States
(12) Patent Application Publication
(10) Pub. No.: US 2013/0124062 A1
(43) Pub. Date: May 16, 2013

(54) VACUUM PRESSURE CONTROL METHOD FOR BRAKE BOOSTER OF VEHICLE

(71) Applicant: Ju Hoon SHIN, Suwon-si (KR)

(72) Inventor: Ju Hoon SHIN, Suwon-si (KR)

(73) Assignees: Kia Motors Corporation, Seoul (KR); Hyundai Motor Company, Seoul (KR)

(21) Appl. No.: 13/536,420

(22) Filed: Jun. 28, 2012

(30) Foreign Application Priority Data
Nov. 14, 2011 (KR) 10-2011-0118505

(51) Int. Cl. B60T 13/70

(52) U.S. Cl. 701/78

(57) ABSTRACT

A method for controlling a brake pressure of a vehicle may include determining whether the negative pressure of a brake booster is larger than the predetermined value, when a brake pedal is operated, detecting the hydraulic pressure change rate through the operation of the brake pedal, when the negative pressure is not larger than the predetermined value, determining a necessary braking force according to the detected hydraulic pressure change rate, determining whether the determined necessary braking force is larger than a generated hydraulic pressure by the operation of the brake pedal, generating an added hydraulic pressure of as much as a difference between the necessary braking force and the generated hydraulic pressure when the determined necessary braking force is larger than the generated hydraulic pressure by the operation of the brake pedal, and performing braking by transferring the generated hydraulic pressure and the added hydraulic pressure to the wheel brake.

### CROSS-REFERENCE TO RELATED APPLICATION

The present application claims priority to Korean Patent Application No. 10-2011-0118505 filed in the Korean Intellectual Property Office on Nov. 14, 2011, the entire contents of which is incorporated herein for all purposes by this reference.

### BACKGROUND OF THE INVENTION

1. Field of the Invention

The present invention relates to a method for controlling a brake negative pressure of a vehicle. More particularly, the present invention relates to a method for controlling a brake negative pressure that is applied to a vehicle having a GDI engine.

2. Description of Related Art

Generally, a GDI (gasoline direct injection) engine advances catalyst heating at an early operating stage of an engine through combustion improvement characteristics. An activated catalyst is used to reduce harmful material at an early operating stage of an engine.

The activated catalyst reduces negative pressure of the engine to cause a shortage of brake negative pressure. That is, there can be a problem that the brake performance is deteriorated in the GDI engine.

There is a method for generating a brake negative pressure in which a vacuum pump or an electric vacuum pump is disposed in an engine so as to resolve the above problem in a conventional art. However, this method necessarily adds an additional device to increase cost and weight of the vehicle, and simultaneously there is a drawback of complicating a manufacturing process. Also, the vacuum pump makes NVH (noise, vibration, and harshness) of the vehicle worse.

Further, a brake negative pressure control method using an ECS (electronic skid control) system has been developed as an alternative method to the vacuum pump. Here, the ESC is a type of ABS (anti-lock brake system). In this method, a necessary braking force is calculated based on the signal of the pedal stroke sensor, and a braking force that can be generated is calculated based on the signal of the negative pressure sensor. Further, if the necessary braking force is larger than the braking force that can be generated, the ESC system generates a braking force of as much as a difference between the necessary braking force and the braking force that can be generated.

Meanwhile, the brake negative pressure control method using a conventional ESC system uses a pedal stroke sensor and a negative pressure sensor, which increases manufacturing cost.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY

Various aspects of the present invention are directed to providing a method for controlling a brake negative pressure of a vehicle having advantages of reducing the number of sensors that are applied thereon.

In an aspect of the present invention, a method for controlling a brake pressure of a vehicle that may include an ESC (electronic skid control) system including a negative pressure switch that compares a negative pressure of a brake booster with a predetermined value and a hydraulic pressure sensor that detects a hydraulic pressure change rate inside the brake booster, may include determining whether the negative pressure of the brake booster is larger than the predetermined value, when a brake pedal is operated, detecting the hydraulic pressure change rate through the operation of the brake pedal, when the negative pressure of the brake booster is not larger than the predetermined value, determining a necessary braking force according to the detected hydraulic pressure change rate when the negative pressure of the brake booster is not larger than the predetermined value, determining whether the determined necessary braking force is larger than a generated hydraulic pressure by the operation of the brake pedal, generating an added hydraulic pressure of as much as a difference between the necessary braking force and the generated hydraulic pressure when the determined necessary braking force is larger than the generated hydraulic pressure by the operation of the brake pedal, and performing braking by transferring the generated hydraulic pressure and the added hydraulic pressure to the wheel brake.

The generated hydraulic pressure that is generated by the operation of the brake pedal is transferred to the wheel brake to perform braking, when the negative pressure of the brake booster is larger than the predetermined value.

The added hydraulic pressure difference of as much as the necessary braking force and the generated hydraulic pressure, and the generated hydraulic pressure are transferred to the wheel brake to perform braking, when the necessary braking force is larger than the generated hydraulic pressure.

The generated hydraulic pressure is transferred to the wheel brake, when the necessary braking force is not larger than the generated hydraulic pressure.

The ESC system may include a control unit that compares and transfers hydraulic pressure and generates the added hydraulic pressure.

A conventional brake negative pressure control method is applied to an ECS system according to an exemplary embodiment of the present invention as described. Accordingly, a separate system is not necessary.

Also, a pedal stroke sensor and a negative pressure sensor need not be used. Accordingly, a manufacturing cost is saved and a manufacturing process is simple.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a block diagram of a brake negative pressure control apparatus of a vehicle according to an exemplary embodiment of the present invention.

FIG. 2 is a flowchart of a brake negative pressure control method of a vehicle according to an exemplary embodiment of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that the present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

An exemplary embodiment of the present invention will hereinafter be described in detail with reference to the accompanying drawings.

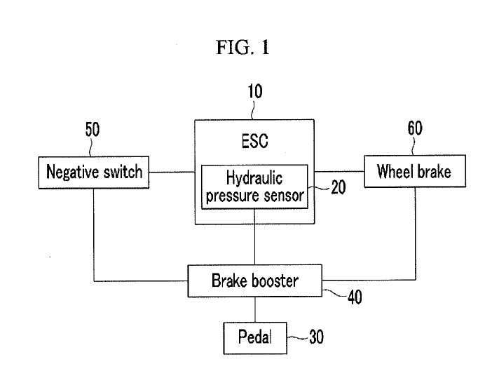

FIG. 1 is a block diagram of a brake negative pressure control apparatus of a vehicle according to an exemplary embodiment of the present invention.

As shown in FIG. 1, a brake negative pressure control apparatus of a vehicle according to an exemplary embodiment of the present invention includes an ESC (electronic skid control) unit 10, a brake booster 40, a hydraulic pressure sensor 20, a negative pressure switch 50, and a wheel brake 60.

The ESC unit 10 is included in an ESC system. Also, the ESC unit 10 compares, transfers, and generates a hydraulic pressure. Here, the ESC system is a kind of ABS (anti-lock brake system). The ABS is a safety system that prevents locking of a tire during braking, and as the ABS is known to a person skilled in the art, the detailed description thereof will be omitted.

The brake booster 40 uses a negative pressure that is formed therein to generate a hydraulic pressure necessary for braking. Also, the behavior for generating the hydraulic pressure is performed by operating the brake pedal 30. That is, the brake booster 40 is connected to the brake pedal 30.

The hydraulic pressure sensor 20 is prepared in the ESC unit 10 and is connected to the brake booster 40. Also, the hydraulic pressure sensor 20 detects a hydraulic pressure change rate and generated hydraulic pressure of the brake booster 40. Further, it transfers the hydraulic pressure change rate and the generated hydraulic pressure to the ESC unit 10.

The negative pressure switch 50 is connected to the brake booster 40 and compares the negative pressure inside the brake booster 40 with a predetermined value. Further, the negative pressure switch 50 is connected to the ESC unit 10, and transfers the signal to the ESC unit if the negative pressure is less than a predetermined value.

The wheel brake 60 can be a conventional brake type that is disposed in a wheel. Also, the wheel brake 60 is connected to the brake booster 40 and receives the hydraulic pressure that is necessary for the braking from the brake booster 40. Further, the wheel brake 60 is connected to the ESC unit 10 and receives the hydraulic pressure that is necessary for the braking from the ESC unit 10.

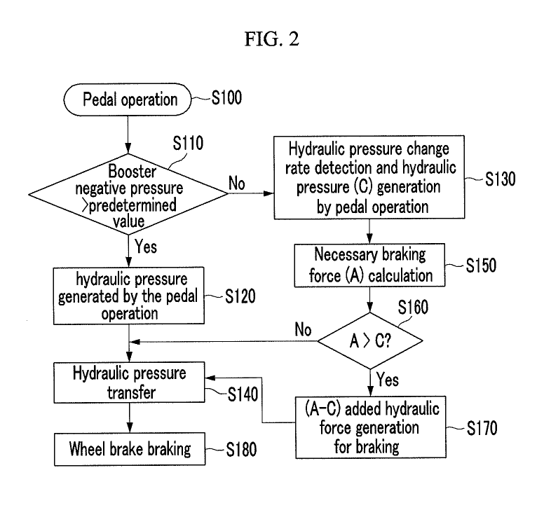

FIG. 2 is a flowchart of a brake negative pressure control method of a vehicle according to an exemplary embodiment of the present invention.

As shown in FIG. 2, if the brake pedal 30 is operated (S100), the negative pressure switch 50 determines whether the negative pressure of the brake booster 40 is larger than a predetermined value (K) (S110).

If the negative pressure is larger than a predetermined value (K), the hydraulic pressure (B) that is generated by the operation of the brake pedal 30 is transferred to the wheel brake 60 (S120 and S140). Also, the wheel brake 60 performs braking through the transferred hydraulic pressure (B) (S180).

If the negative pressure is less than a predetermined value (K), the hydraulic pressure sensor 20 detects a hydraulic pressure change rate and a generated hydraulic pressure (C) that is formed in the brake booster 40 by the operation of the brake pedal 30 (S130). Also, the ESC unit 10 calculates a hydraulic pressure (A) that is necessary for the braking according to the hydraulic pressure change rate (S150).

If the necessary hydraulic pressure (A) is calculated, the ESC unit 10 determines whether the hydraulic pressure (A) is larger than the generated hydraulic pressure (C) (S160).

If the hydraulic pressure (A) is not larger than the generated hydraulic pressure (C), the generated hydraulic pressure(C) is transferred to the wheel brake 60 (S140). The wheel brake 60 performs braking through the transferred hydraulic pressure (C) (S180).

If it is determined that the hydraulic pressure (A) is larger than the generated hydraulic pressure (C), the ESC unit 10 generates an additional hydraulic pressure (A-C) of as much as a difference between the hydraulic pressure (A) and the generated hydraulic pressure (C) (S170). The added hydraulic pressure (A-C) and the generated hydraulic pressure (C) are transferred to the wheel brake 60 (S140). That is, the wheel brake 60 receives hydraulic pressure that is equal to the magnitude of the hydraulic pressure (A) that is necessary for the braking. The wheel brake 60 uses the hydraulic pressure (A) to perform the braking (S180).

The brake negative pressure control method of a vehicle according to an exemplary embodiment of the present invention as described above can be applied to the ECS system that is used in a conventional brake negative pressure control method. Accordingly, a new separate system is not necessary. Also, a pedal stroke sensor and a negative pressure sensor are not used. Accordingly, the manufacturing cost and process can be reduced.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A method for controlling a brake pressure of a vehicle that includes an ESC (electronic skid control) system including a negative pressure switch that compares a negative pressure of a brake booster with a predetermined value and a hydraulic pressure sensor that detects a hydraulic pressure change rate inside the brake booster, comprising:
determining whether the negative pressure of the brake booster is larger than the predetermined value, when a brake pedal is operated;
detecting the hydraulic pressure change rate through the operation of the brake pedal, when the negative pressure of the brake booster is not larger than the predetermined value;
determining a necessary braking force according to the detected hydraulic pressure change rate when the negative pressure of the brake booster is not larger than the predetermined value;
determining whether the determined necessary braking force is larger than a generated hydraulic pressure by the operation of the brake pedal;
generating an added hydraulic pressure of as much as a difference between the necessary braking force and the generated hydraulic pressure when the determined necessary braking force is larger than the generated hydraulic pressure by the operation of the brake pedal; and
performing braking by transferring the generated hydraulic pressure and the added hydraulic pressure to the wheel brake.

2. The method of claim 1, wherein the generated hydraulic pressure that is generated by the operation of the brake pedal is transferred to the wheel brake to perform braking, when the negative pressure of the brake booster is larger than the predetermined value.

3. The method of claim 1, wherein the added hydraulic pressure difference of as much as the necessary braking force and the generated hydraulic pressure, and the generated hydraulic pressure are transferred to the wheel brake to perform braking, when the necessary braking force is larger than the generated hydraulic pressure.

4. The method of claim 1, wherein the generated hydraulic pressure is transferred to the wheel brake, when the necessary braking force is not larger than the generated hydraulic pressure.

5. The method of claim 1, wherein the ESC system includes a control unit that compares and transfers hydraulic pressure and generates the added hydraulic pressure.
